(19) United States
(12) Patent Application Publication
(10) Pub. No.: US 2008/0085005 A1
(43) Pub. Date: Apr. 10, 2008

(54) Method and apparatus for broadcast encryption using bilinear map

(75) Inventors: Bae Eun Jung, Yongin-si (KR); Maeng Hee Sung, Yongin-si (KR); Weon iI Jin, Yongin-si (KR); Hee Jean Kim, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/723,533

(22) Filed: Mar. 20, 2007

(30) Foreign Application Priority Data
Sep. 29, 2006 (KR) 10-2006-0096309

(51) Int. Cl. H04L 9/30; G06F 7/58; H04L 9/08

(52) U.S. Cl. 380/282; 380/46

(57) ABSTRACT

A method and apparatus are provided for broadcast encryption using a bilinear map, defined on elliptic curves. The method for the broadcast encryption using the bilinear map includes generating a first random number for all nodes except for a plurality of leaf nodes of an a-ary tree structure, configured in a plurality of depths, generating ‘a’ pieces of a second random number to allocate the generated second random number to all nodes except for a root node of the a-ary tree structure, generating public key information by applying the second random number to a second cyclic group, and generating a secret key group by applying the first and the second random numbers to a first cyclic group.

### CROSS-REFERENCE TO RELATED APPLICATION

This application claims the benefit under 35 U.S.C. §119(a) of Korean Patent Application No. 10-2006-0096309, filed Sep. 29, 2006, in the Korean Intellectual Property Office, the entire disclosure of which is incorporated herein by reference.

### BACKGROUND OF THE INVENTION

1. Field of the Invention

The present invention relates to a broadcast encryption algorithm. More particularly, the present invention relates to a method and apparatus for broadcast encryption which uses a bilinear map, defined on elliptic curves capable of reducing information quantity of an encryption key group, corresponding to a secret key of a user terminal.

2. Description of Related Art

Generally, a broadcast encryption algorithm is applied to environments having a large number of users, and environments where performing a handshake between a server and a terminal is difficult, such as an environment which broadcasts contents. The broadcast encryption algorithm is a method of transmitting information to only users desired by a sender, among all users. The method is effectively used only when a set of users, receiving the information, randomly and dynamically changes.

When the broadcast encryption algorithm is applied to a contents service, it can be assumed that the server has generated and distributed a device key set to each user device. Then, whenever the server sends contents, it encrypts the contents with a contents key and encrypts the contents key so that only privileged users can obtain the contents key. The encrypted data of the contents key is called a header. The size of the header is called transmission overhead. However, due to the capacity of user devices, the size of the device key set stored in each device and computation costs for each device to obtain the contents key are also important parameters. The size of a device key set is called storage overhead, and the computation costs are called computation overhead. This device key set will hereinafter be referred to as the encryption key group. The server further simultaneously transmits information about the terminals which are revoked.

The broadcast encryption algorithm is generally configured in a tree structure. Examples of such algorithms include a complete subtree (CS), a subset difference (SD), a HBES algorithm, a CuBES algorithm and the algorithm suggested by T. Asano. With respect to the broadcast encryption algorithm, there have been great efforts to reduce transmission overhead, storage overhead, computation overhead, and so forth.

Accordingly, a need exists for a method and apparatus for effectively and efficiently reducing information quantity of an encryption key group.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a method for broadcast encryption using a bilinear map capable of reducing information quantity of an encryption key group which corresponds to a secret key of a user terminal using public key information that is known to all user nodes, and a secret key group, corresponding to each of the user nodes, generated using the bilinear map, defined on elliptic curves, and an apparatus using the method.

According to an aspect of exemplary embodiments of the present invention, a method is provided for broadcast encryption using a bilinear map comprising generating a first random number for all nodes except for a plurality of leaf nodes of an a-ary tree structure, configured in a plurality of depths, generating ‘a’ pieces of a second random number to allocate the generated second random number to all nodes except for a root node of the a-ary tree structure, generating public key information by applying the second random number to a second cyclic group, and generating a secret key group by applying the first and the second random numbers to a first cyclic group.

According to another aspect of exemplary embodiments of the present invention, an apparatus is provided for broadcast encryption using a bilinear map comprising a first random number generator for generating a first random number for all nodes except for a plurality of leaf nodes of an a-ary tree structure, configured in a plurality of depths, a second random number generator for generating ‘a’ pieces of a second random number to allocate the generated second random number to all nodes except for a root node of the a-ary tree structure, a public key information generator for generating public key information by applying the second random number to a second cyclic group, and a secret key group generator for generating a secret key group by applying the first and the second random numbers to a first cyclic group.

Other objects, advantages, and salient features of the present invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features, and advantages of certain exemplary embodiments of the present invention will become more apparent from the following detailed description, taken in conjunction with the accompanying drawings, in which:

FIG. 1 is a diagram illustrating a network providing a broadcast encryption algorithm using a bilinear map according to an exemplary embodiment of the present invention;

FIG. 2 is a flowchart illustrating a method for broadcast encryption using a bilinear map according to an exemplary embodiment of the present invention;

FIG. 3 is a diagram illustrating a method of generating a first random number for broadcast encryption using a bilinear map according to an exemplary embodiment of the present invention;

FIG. 4 is a diagram illustrating a method of generating a second random number for broadcast encryption using a bilinear map according to an exemplary embodiment of the present invention;

FIG. 5 is a diagram illustrating a method of generating public key information for broadcast encryption using a bilinear map according to an exemplary embodiment of the present invention;

FIG. 6 is a diagram illustrating a method of generating a secret key group for broadcast encryption using a bilinear map according to an exemplary embodiment of the present invention;

FIG. 7 is a diagram illustrating a method of selecting an inner group key for broadcast encryption using a bilinear map according to an exemplary embodiment of the present invention; and

FIG. 8 is a block diagram illustrating an apparatus for broadcast encryption using a bilinear map according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description, such as detailed constructions and elements, are provided to assist in a comprehensive understanding of exemplary embodiments of the present invention. Accordingly, those of ordinary skill in the art will recognize that various changes and modifications of the exemplary embodiments described herein can be made without departing from the scope and spirit of the present invention. Also, descriptions of well-known functions and constructions are omitted for clarity and conciseness.

The user terminal, which provides the broadcast encryption algorithm using a bilinear map according to an exemplary embodiment of the present invention, can be embodied as any one or more of a mobile communication terminal, a public switched telephone network (PSTN) terminal, a voice over Internet protocol (VoIP) terminal, a session initiation protocol (SIP) terminal, a media gateway control (Megaco) terminal, a personal digital assistant (PDA), a mobile phone, a personal communication service (PCS) phone, a hand-held personal computer (PC), a Code Division Multiple Access (CDMA)-2000 (1X, 3X) phone, a Wideband CDMA phone, a dual band/dual mode phone, a Global System for Mobile Communications (GSM) phone, a mobile broadband system (MBS) phone, a satellite/terrestrial Digital Multimedia Broadcasting (DMB) phone, and the like.

Embodiments of the present invention provide an effective broadcast encryption algorithm, based on an a-ary tree using a bilinear map, defined on elliptic curves. According to embodiments of the present invention, a user node stores only one secret key in each depth of the a-ary tree, and performs only one bilinear map operation in order to obtain an inner group key. The bilinear map is described in greater detail below.

Consider, for example, three groups G₁, G₂, and G_{T} where the bilinear map ê is defined. The groups G₁ and G₂ are cyclic groups such that it is difficult to solve CDH (Computational Diffie-Hellman) and their order is a large prime number p. The CDH assumption is related to a discrete logarithm assumption, which holds that computing the discrete logarithm of a value base a generator g is difficult.

Two generation elements are used to generate the two cyclic groups since a cyclic group is generated by a single generation element. Specifically, a generation element for a first cyclic group G₁ is referred to as g₁, and a generation element for a second cyclic group G₂ is referred to as g₂. In this case, assuming for example that there is the bilinear map satisfying ê: G₁×G₂->G_{T} follows:

(1) For any integers a, b, and (P, Q)εG₁×G₂, ê(P^{a}, Q^{b})=ê(P, Q)^{ab};

(2) Given (P, Q)εG₁×G₂, there is an efficient algorithm to calculate ê(P, Q)εG_{T};

(3) It is difficult to calculate (X, Y) such that ê(X, Y)=Z for a given Z; and

(4) ê(G₁×G₂) (⊂G_{T}) is also a cyclic group with order ‘p’, and it is difficult to solve the Computational Diffie-Hellman (CDH) problem. In this case, the CDH problem indicates finding ‘x’ when a generation element is ‘g’ of a cyclic group, and when g^{x} is known.

Also, the cyclic groups G₁ and G₂ can be the same group. Hereinafter, a broadcast encryption algorithm using the bilinear map ê satisfying the cryptosystem will be described in greater detail.

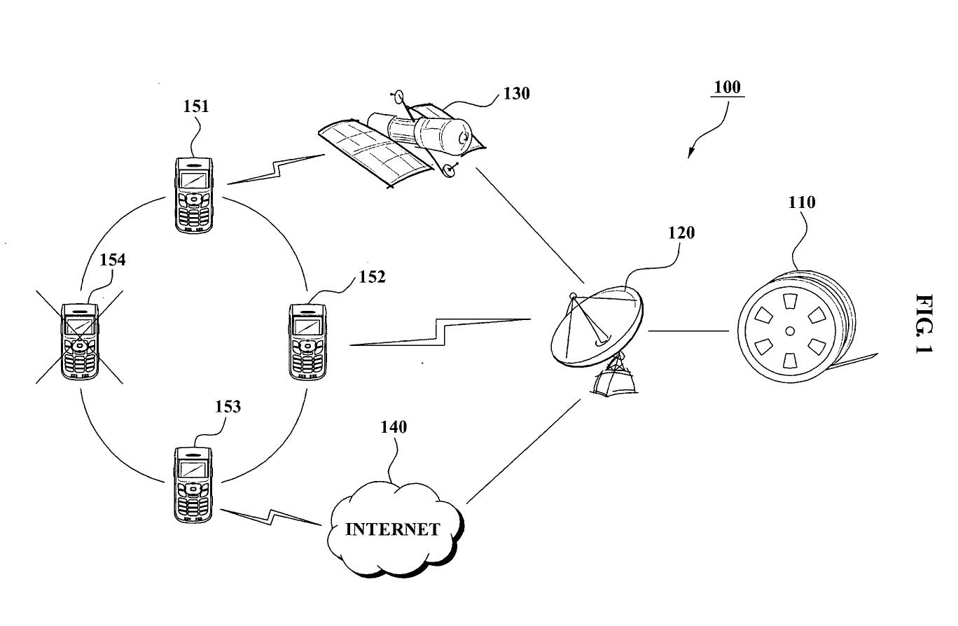

FIG. 1 is a diagram illustrating a network 100 providing a broadcast encryption algorithm using a bilinear map according to an exemplary embodiment of the present invention.

As illustrated in FIG. 1, the network providing the broadcast encryption algorithm using the bilinear map according to an exemplary embodiment of the present invention comprises a contents provider 110, a service provider 120, a satellite 130, an Internet 140, and user terminals 151, 152, 153 and 154. The network of FIG. 1 is presented as an example only, and additional elements can be added or omitted in yet other exemplary embodiments of the present invention.

The contents provider 110 produces various contents including audio data, text data, and video data, and the service provider 120 provides the user terminals 151, 152 and 153, being authorized users, with corresponding contents which have been paid for from among the various contents, via wired/wireless communications such as the satellite 130 and the Internet 140.

The service provider 120 can encrypt the corresponding contents using the broadcast encryption algorithm so that an unauthorized user terminal 154, which for example is not paying for the corresponding contents, cannot use the corresponding contents.

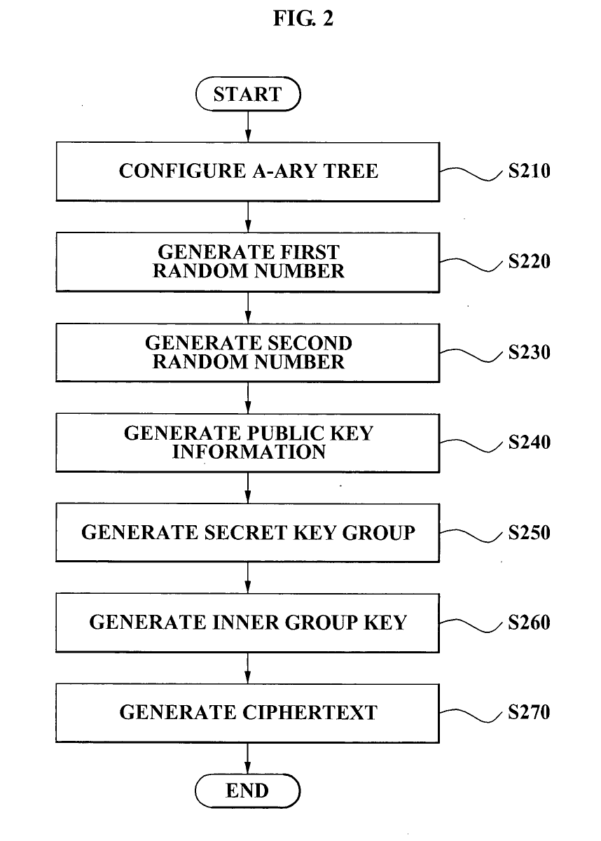

Hereinafter, operations of generating and distributing a key for the broadcast encryption using a bilinear map will be described in greater detail below by referring to FIGS. 2 through 8.

FIG. 2 is a flowchart illustrating a method for broadcast encryption using a bilinear map according to an exemplary embodiment of the present invention.

As illustrated in FIG. 2, the method for broadcast encryption using the bilinear map according to an embodiment of the present invention comprises operations S210, S220, S230, S240, S250, S260 and S270. An a-ary tree structure is configured in operation S210, a first random number is generated in operation S220, a second random number is generated in operation S230, public key information is generated in operation S240, a secret key group is generated in operation S250, an inner group key is generated in operation S260, and ciphertext is generated in operation S270. Each operation is described in greater detail below.

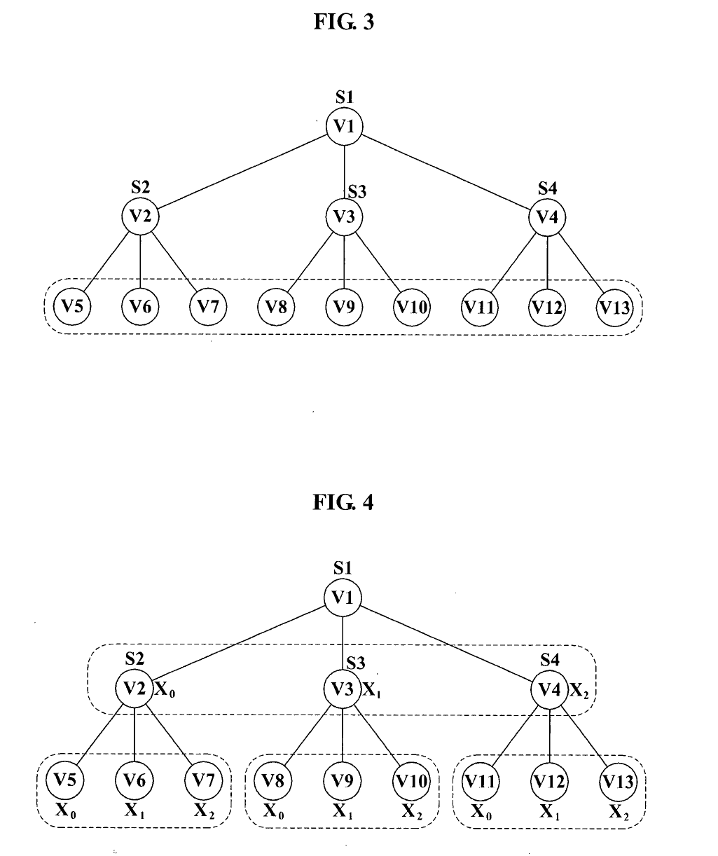

In operation S210, the a-ary tree structure, configured in a plurality of depths, is configured. In operation S220, the first random number Sᵢ is generated on all nodes except for a plurality of leaf nodes, i.e. a root node and a plurality of internal nodes, in the a-ary tree structure, which is described in greater detail below by referring to FIG. 3.

FIG. 3 is a diagram illustrating a method of generating a first random number for broadcast encryption using a bilinear map according to an exemplary embodiment of the present invention.

As illustrated in FIG. 3, the method of generating the first random number for broadcast encryption using the bilinear map according to an embodiment of the present invention can allocate the first random number Sᵢ to each of all of the nodes, e.g. from the root node to the plurality of internal nodes, in the a-ary tree structure. As an example, a first random number S₁ is allocated to the root node V1, and first random numbers S₂, S₃, . . . , Sᵢ are sequentially allocated to all descendent nodes V2-V4 except for the plurality of leaf nodes V5-V13, at each depth level. In this case, the first random numbers are calculated by modulo reduction with a predetermined number which is an order of the first and the second cyclic groups.

Also, in operation S230, ‘a’ pieces of a second random number Xᵢ is generated to allocate the generated second random number to all nodes except for the root node, in the a-ary tree structure, which is described in greater detail below by referring to FIG. 4.

FIG. 4 is a diagram illustrating a method of generating a second random number for broadcast encryption using a bilinear map according to an exemplary embodiment of the present invention.

As illustrated in FIG. 4, the method of generating the second random number for broadcast encryption using the bilinear map according to an embodiment of the present invention generates the ‘a’ pieces of the second random number, classifies, into a single small group, each of the ‘a’ pieces of descendent nodes, having an identical depth and an identical ancestor node, from the root node to the plurality of leaf nodes, and allocates the second random number to the ‘a’ pieces of descendent nodes, included in the classified small group. In this case, the second random numbers are calculated by modulo reduction with a predetermined number which is an order of the first and the second cyclic groups.

Supposing, for example, that X₀, X₁, and X₂ are generated for the second random number when ‘a’ is three. Descendent nodes V2, V3 and V4, having a depth 1 and an ancestor node V1, can be classified into a single group. X₀ can be allocated to V2, X₁ can be allocated to V3, and X₂ can be allocated to V4.

In this way, descendent nodes V5, V6 and V7, having a depth 2 and an ancestor node V2, descendent nodes V8, V9 and V10, having a depth 2 and an ancestor node V3, and descendent nodes V11, V12 and V13, having a depth 2 and an ancestor node V4, can be classified into each of the classified small groups. Also, a corresponding second random number can be allocated to the ‘a’ pieces of descendent nodes, included in the each of the classified small groups.

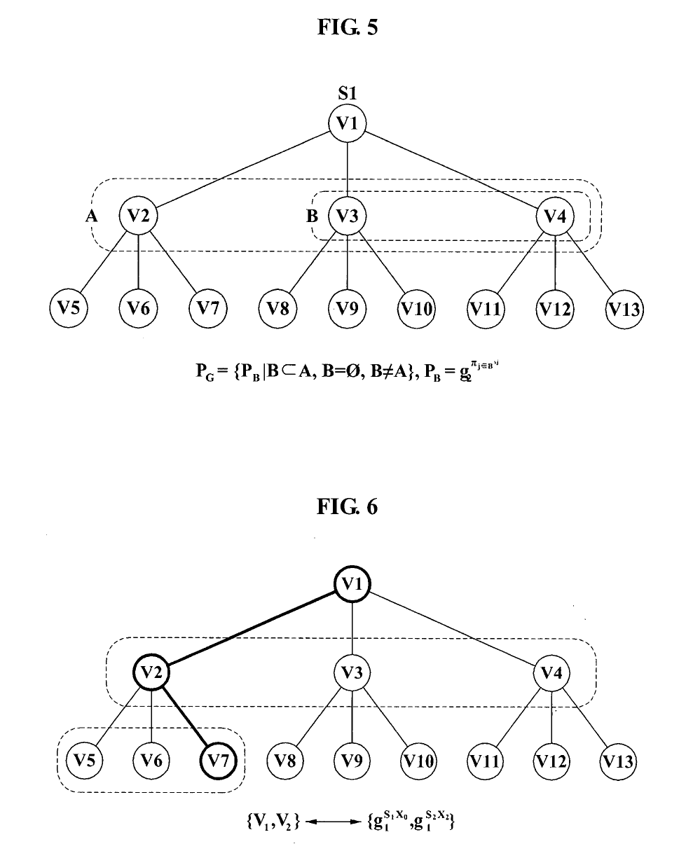

In operation S240, public key information is generated by applying the second random number to the second cyclic group G₂, and a method of generating the public key information P_{G} is described in greater detail below by referring to FIG. 5.

FIG. 5 is a diagram illustrating a method of generating public key information for broadcast encryption using a bilinear map according to an exemplary embodiment of the present invention.

As illustrated in FIG. 5, the method of generating the public key information, by applying the second random number to the second cyclic group G₂ of embodiments of the present invention, defines a set “A”, configured in ‘a’ pieces from indexes 0 to a−1. The pubic key information, corresponding to a subset “B”, can be generated when there is the subset B of the set A. The generated public key information can then be transmitted to all leaf nodes.

In some cases, the public key information comprising a public key is not required to be generated since it is meaningless when B=ø or B=A with respect to the subset B of the set A. The public key information P_{G} defining a public key P_{B} is represented as shown below in Equation (1).

$${P}_{G} = \{ {P}_{B} \vert B ⋐ A , B \neq 0 , B \neq A \} , {P}_{B} = {g}_{2}^{{Π}_{∀ i ε {B}^{{x}_{i}}}} \qquad [ Equation 1 ]$$

As an example, for a predetermined group A={0, 1, 2}, a number of possible subsets of the group A is 2^{a}-2, that is 6 comprising {0}, {1}, {2}, {0, 1}, {0, 2} and {1, 2}. Particularly, the public key P_{B} can be represented as,
g₂^{x}^{₁}^{·x}^{₂}
when the subset B={1,2}.

Also, a secret key group is generated by applying the first random number Sᵢ and the second random number Xᵢ to the first cyclic group G₁, which is described in greater detail below by referring to FIG. 6.

FIG. 6 is a diagram illustrating a method of generating a secret key group for broadcast encryption using a bilinear map according to an exemplary embodiment of the present invention.

As illustrated in FIG. 6, the method of generating the secret key group for broadcast encryption using the bilinear map according to an exemplary embodiment of the present invention can generate the secret key group, including a secret key on a path of ancestor nodes of each of the leaf nodes. The secret key group can be generated by applying the first random number Sᵢ and the second random number Xᵢ to the first cyclic group G₁.

As an example, a method of generating a secret key group for a user terminal, corresponding to the leaf node V7 is described in greater detail below as follows.

Initially, in order to generate the secret key group for the user terminal, corresponding to the leaf node V7, secret keys, which are generated on a plurality of nodes on a path, from a highest ancestor node V1 to the leaf node V7, are included, and the plurality of nodes can include V2 and V7.

The ancestor node V2 can generate a secret key,
g₁^{s}^{₁}^{·x}^{₀}
by applying a first random number S₁, allocated to the highest ancestor node V1, and a second random number X₀, allocated to the ancestor node V2. The leaf node V7 can generate a secret key,
g₁^{s}^{₂}^{·x}^{₂}
by applying a first random number S₂, allocated to the highest ancestor node V2, and a second random number X₂, allocated to the leaf node V7.

Consequently, the secret key group for the user terminal, corresponding to the leaf node V7, can include,
{g₁^{s}^{₁}^{·x}^{₀},g₁^{s}^{₂}^{·x}^{₂}},
generated by applying the first and the second random numbers, allocated to all of the nodes from the highest ancestor nodes V1 to a lowest node V7 on the path, to the first cyclic group G₁.

Similarly, a secret key group, corresponding to each of the leaf nodes V5 through V13 of the configured a-ary tree structure, can be generated and provided to the user terminals, corresponding to the plurality of leaf nodes V5 through V13.

Returning to FIG. 2, in operation S260, an inner group key for encryption of transmission information K is generated using the generated public key information and secret key group. An inner group key GK(Vᵢ)_{T} with respect to a subset T, including authorized nodes, is represented as shown below by Equation (2).

$${GK ( {v}_{i} )}_{T} = \hat{e} ( {g}_{1}^{{s}_{4}} , {P}_{T} ) = \hat{e} ( {g}_{1}^{{s}_{4}} , {g}_{2}^{{Π}_{∀ j ε {T}^{{x}_{j}}}} ) = {\hat{e} ( {g}_{1} , {g}_{2} )}^{{( Π ∀ j ε {T}^{{x}_{j}} )}^{{s}_{4}}} \qquad [ Equation 2 ]$$

When a node having an index value 1 is included in the subset T of an inner group, by applying the aforementioned cryptosystem (1) of the bilinear map to Equation (2), the result is represented as shown below by Equation (3).

$${\hat{e} ( {g}_{1} , {g}_{2} )}^{{S}_{i} {Π}_{∀ j ε {T}^{{x}_{j}}}} = \hat{e} ( {g}_{1}^{{s}_{i} \cdot {x}_{1}} , {g}_{2}^{{Π}_{∀ j ε T - {\{ l \}}^{{x}_{j}}}} ) \qquad [ Equation 3 ]$$

A corresponding user node that knows the secret key,
g₁^{s}^{ᵢ}^{·x}^{ᵢ}
can obtain the inner group key GK(Vᵢ)_{T} since the,

$${g}_{2}^{{Π}_{∀ j ε T - {\{ l \}}^{{x}_{j}}}}$$

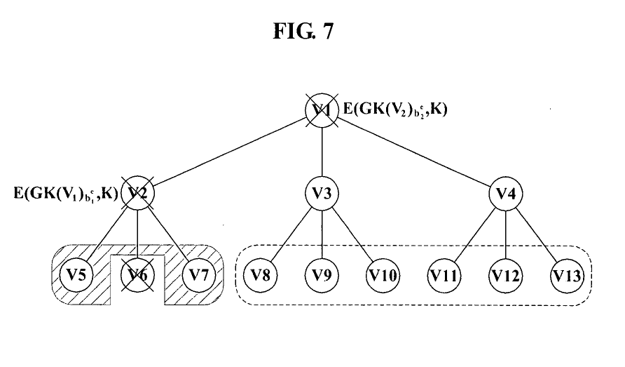

is public key information. In this case, there can be an unauthorized user that is not paying for corresponding contents. According to implementations of embodiments of the present invention, the unauthorized user is not allowed to use the corresponding contents, which is described in greater detail below by referring to FIG. 7.

FIG. 7 is a diagram illustrating a method of selecting an inner group key for broadcast encryption using a bilinear map according to an exemplary embodiment of the present invention.

As illustrated in FIG. 7, a service provider 120 can select an inner group key GK(Vᵢ)_{T} that cannot be shared by a leaf node V6, corresponding to the unauthorized user, and transmit to nodes V5 through V13 when there is such an unauthorized user that is not paying for the corresponding contents.

As an example, an unauthorized user V6 is shown, such as one that is not paying for the corresponding contents.

In the operation S270, the service provider 120 of FIG. 1 generates the inner group key from all ancestor nodes on the path from the unauthorized user node V6 to the highest ancestor node V1, and generates a ciphertext of the transmission information K to be shared as the generated inner group key. In this case, the inner group key generated from all ancestor nodes is represented as shown below by Equation (4).

$${GK ( {v}_{{a}_{i}} )}_{{b}_{i}^{c}} = {\hat{e} ( {g}_{1} , {g}_{2} )}^{( {Π}_{∀ j , j \neq {b}_{i}} {x}_{j} ) \cdot {s}_{{a}_{i}}} \qquad [ Equation 4 ]$$

In this case, Vₐᵢ denotes each index of the ancestor nodes of the unauthorized user node, bᵢ denotes its own index of an inner group, based on each ancestor node of the unauthorized user node, and bᵢ^{c} denotes all nodes except for a node having an index bᵢ from the inner group.

The service provider 120 generates a calculated inner group key,

$${GK ( {v}_{{a}_{1}} )}_{{b}_{1}^{c}}$$

on the highest ancestor node V1 of the unauthorized user node V6, generates a ciphertext,

$$E ( {GK ( {v}_{{a}_{1}} )}_{{b}_{1}^{c}} , K )$$

which is encrypted with the generated inner group key, generates a calculated inner group key,

$${GK ( {v}_{{a}_{2}} )}_{{b}_{2}^{c}}$$

on an ancestor node V2 of the unauthorized user node V6, and generates a ciphertext,

$$E ( {GK ( {v}_{{a}_{2}} )}_{{b}_{2}^{c}} , K )$$

which is encrypted with the generated inner group key.

The contents can be broadcast to all of the users except for the unauthorized user node V6 since the service provider 120 generates header information, including the plurality of ciphertexts that are encrypted with the inner group key, and transmits the generated header information and the unauthorized user terminal information.

Similarly, the user node can calculate an inner group key for encryption since the user nodes can determine which public key to use, according to the unauthorized user terminal information. This is represented as shown below in Equation (5).

$${GK ( {v}_{{c}_{i - 1}} )}_{T} = {\hat{e} ( {g}_{1} , {g}_{2} )}^{{s}_{{c}_{l - 1}} Π ∀ iε {T}^{{x}_{i}}} \qquad [ Equation 5 ]$$

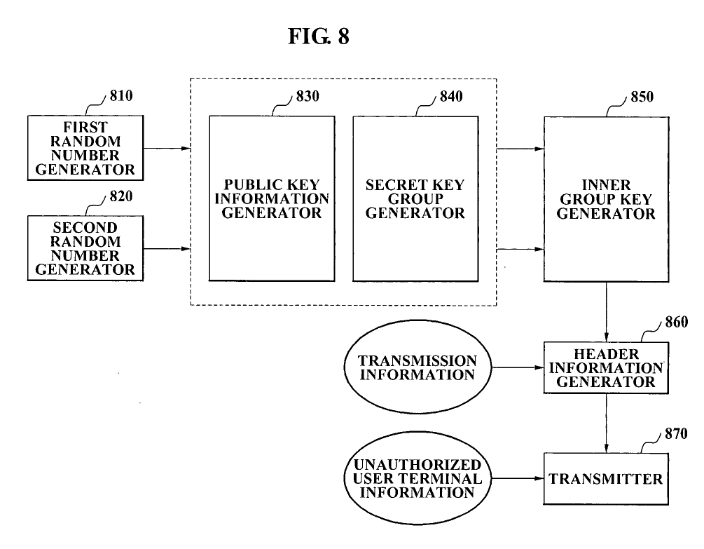

FIG. 8 is a diagram illustrating an apparatus for broadcast encryption using a bilinear map according to an exemplary embodiment of the present invention.

As illustrated in FIG. 8, the apparatus for broadcast encryption using the bilinear map according to an exemplary embodiment of the present invention comprises a first random number generator 810, a second random number generator 820, a public key information generator 830, a secret key group generator 840, an inner group key generator 850, a header information generator 860, and a transmitter 870.

The first random number generator 810 generates a first random number for all nodes except for a plurality of leaf nodes of an a-ary tree structure, configured in a plurality of depths. The second random number generator 820 generates ‘a’ pieces of a second random number to logically allocate the generated second random number to all nodes except for a root node of the a-ary tree structure. The first and second random number generators 810 and 820 can generate the first random number and the second random number by modulo calculating a predetermined number and an order of the first cyclic group or the second cyclic group.

In this case, the second random number generator 820 generates the ‘a’ pieces of the second random number, classifies ‘a’ pieces of descendent nodes, having an identical depth and an identical ancestor node, into a single small group, and allocates the second random number to each of the ‘a’ pieces of descendent nodes, included in the classified small group.

The pubic key information generator 830 generates public key information by applying the second random number to a second cyclic group G₂. The secret key group generator 840 generates a secret key group by applying the first and the second random numbers to a first cyclic group G₁. The generated public key information can be provided to user terminals, corresponding to all leaf nodes, via the transmitter 870. In this case, the generated secret key group can be provided to the user terminals, corresponding to each of the leaf nodes, at a point in time when the user terminals are registered in a server or the user terminals are manufactured.

The inner group key generator 850 generates a plurality of inner group keys, including the public key information and the secret key group when there is an unauthorized user terminal, corresponding to any one of the leaf nodes. The header information generator 860 generates a plurality of ciphertexts, which have encrypted transmission information with the inner group keys, and generates header information, including the generated plurality of ciphertexts.

Consequently, all of the user terminals can receive the generated header information and the unauthorized user terminal information since the transmitter 870 transmits the header information and the unauthorized user terminal information to all of the user terminals, corresponding to the leaf nodes.

Each of the user terminals can receive the header information and the unauthorized user terminal information, and can calculate a corresponding inner group key, according to the received unauthorized user terminal information. Accordingly, each of the user terminals can recover the transmission information by searching for the ciphertexts which have been encrypted with the calculated inner group key, from the plurality of ciphertexts included in the header information.

The method for broadcast encryption using a bilinear map according to the above-described exemplary embodiments of the present invention can be recorded in computer-readable media including program instructions to implement various operations embodied by a computer. The media may also include, alone or in combination with the program instructions, data files, data structures, and the like. Examples of computer-readable media include but are not limited to magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, and the like, including a carrier wave transmitting signals specifying the program instructions, data structures, and the like. Examples of program instructions include both machine code, such as those produced by a compiler, and files containing higher level code that may be executed by the computer using an interpreter. The described hardware devices may be configured to act as one or more software modules in order to perform the operations of the above-described embodiments of the present invention.

As described above, the system and method for broadcast encryption using the bilinear map according to embodiments of the present invention can reduce information quantity of an encryption key group which corresponds to a secret key of a user terminal since public key information to be shared by all user nodes, and a secret key group, corresponding to each of the user nodes, is generated using the bilinear map.

While the present invention has been shown and described with reference to certain exemplary embodiments thereof, it will be understood by those skilled in the art that various changes in form and detail may be made therein without departing from the spirit and scope of the invention as defined by the appended claims and their equivalents.

What is claimed is:

1. A method for broadcast encryption using a bilinear map, the method comprising:
generating a first random number for all nodes except for a plurality of leaf nodes of an a-ary tree structure, configured in a plurality of depths;
generating ‘a’ pieces of a second random number to allocate the generated second random number to all nodes except for a root node of the a-ary tree structure;
generating public key information by applying the second random number to a second cyclic group; and
generating a secret key group by applying the first and the second random numbers to a first cyclic group.

2. The method of claim 1, further comprising calculating the first and the second random numbers by modulo reduction with a predetermined number which is an order of the first group or the second cyclic group.

3. The method of claim 1, wherein the generating of the ‘a’ pieces of the second random number comprises:
generating the ‘a’ pieces of the second random number;
classifying, into a group, each of ‘a’ pieces of descendent nodes, having an identical depth and an identical ancestor node; and
allocating the second random number to the each of ‘a’ pieces of descendent nodes, included in the classified group.

4. The method of claim 1, further comprising:
transmitting the generated public key information to all of the leaf nodes.

5. The method of claim 1, wherein the generated secret key group is provided to each of the leaf nodes at a point in time when a terminal is registered in the server or the terminal is manufactured.

6. The method of claim 1, wherein the generating of the secret key group generates a secret key group comprising a same number of secret keys as a number of ancestor nodes of each of the leaf nodes.

7. The method of claim 6, further comprising generating the secret key at a node by applying the first random number allocated to a parent node of a corresponding node and the second random number allocated to the corresponding node to the first cyclic group

8. The method of claim 1, further comprising:
generating a plurality of inner group keys, comprising the public key information and the secret key group, according to an unauthorized user terminal information when an unauthorized user terminal exists corresponding to any one of the leaf nodes; and
generating a plurality of ciphertexts, comprising encrypted transmission information using the generated inner group keys, and generating header information, comprising the generated plurality of ciphertexts, and
wherein the generated header information and the unauthorized user terminal information are transmitted to all user terminals, corresponding to the leaf nodes.

9. The method of claim 8, further comprising controlling at least one of the user terminals to:
receive the header information and the unauthorized user terminal information;
calculate the inner group key according to the unauthorized user terminal information; and
recover the transmission information by searching for the ciphertexts, encrypted using the calculated inner group key, from the plurality of ciphertexts included in the header information.

10. A computer-readable storage medium having stored thereon instructions for broadcast encryption using a bilinear map, comprising:
a first set of instructions for generating a first random number for all nodes except for a plurality of leaf nodes of an a-ary tree structure, configured in a plurality of depths;
a second set of instructions for generating ‘a’ pieces of a second random number to allocate the generated second random number to all nodes except for a root node of the a-ary tree structure;
a third set of instructions for generating public key information by applying the second random number to a second cyclic group; and
a fourth set of instructions for generating a secret key group by applying the first and the second random numbers to a first cyclic group.

11. An apparatus for broadcast encryption using a bilinear map, the apparatus comprising:
a first random number generator for generating a first random number for all nodes except for a plurality of leaf nodes of an a-ary tree structure, configured in a plurality of depths;
a second random number generator for generating ‘a’ pieces of a second random number to allocate the generated second random number to all nodes except for a root node of the a-ary tree structure;
a public key information generator for generating public key information by applying the second random number to a second cyclic group; and
a secret key group generator for generating a secret key group by applying the first and the second random numbers to a first cyclic group.

12. The apparatus of claim 11, wherein the first and the second random number generators are configured to generate the first random number and second random number by modulo reduction with a predetermined number which is an order of the first cyclic group or the second cyclic group.

13. The apparatus of claim 11, wherein the second random generator is configured to:
generate the ‘a’ pieces of the second random number;
classify, into a group, each of ‘a’ pieces of descendent nodes, having an identical depth and an identical ancestor node; and
allocate the second random number to each of the ‘a’ pieces of descendent nodes, included in the classified group.

14. The apparatus of claim 11, further comprising:
a transmitter for transmitting the generated public key information to all of the leaf nodes, or transmitting the generated secret key group to each of the leaf nodes.

15. The apparatus of claim 11, wherein the secret key group generator is configured to generate a secret key group, comprising a same number of secret keys to a number of ancestor nodes of each of the leaf nodes.

16. The apparatus of claim 11, further comprising at least one node configured to generate the secret key by applying the first random number allocated to a parent node of a corresponding node and the second random number allocated to the corresponding node to the first cyclic group.

17. The apparatus of claim 11, further comprising:
an inner group key generator for generating a plurality of inner group keys, comprising the public key information and the secret key group, according to unauthorized user terminal information when an unauthorized user terminal exists corresponding to any one of the leaf nodes;
a header information generator for generating a plurality of ciphertexts comprising encrypted transmission information using the generated inner group keys, and generating header information, including the generated plurality of ciphertexts; and
a transmitter for transmitting the generated header information and the unauthorized user terminal information to all user terminals, corresponding to the leaf nodes.

18. The apparatus of claim 17, wherein each of the user terminals is configured to:
receive the header information and the unauthorized user terminal information;
calculate the inner group key according to the unauthorized user terminal information included in the header; and
recover the transmission information by searching for the ciphertexts which have been encrypted using the calculated inner group key, from the plurality of ciphertexts included in the header information.
